(19) United States
(12) Patent Application Publication
(10) Pub. No.: US 2021/0360224 A1
(43) Pub. Date: Nov. 18, 2021

(54) METHOD AND APPARATUS FOR TRANSMISSION PARAMETER DISTRIBUTION OF VIDEO RESOURCE

(71) Applicant: TENCENT TECHNOLOGY (SHENZHEN) COMPANY LIMITED, Shenzhen (CN)

(72) Inventors: Haichang ZHAI, Shenzhen (CN); Zirong ZHU, Shenzhen (CN); Hao LI, Shenzhen (CN); Jun ZHAO, Shenzhen (CN); Liang WANG, Shenzhen (CN)

(73) Assignee: TENCENT TECHNOLOGY (SHENZHEN) COMPANY LIMITED, Shenzhen (CN)

(21) Appl. No.: 17/443,773

(22) Filed: Jul. 27, 2021

Related U.S. Application Data
(63) Continuation of application No. PCT/CN2020/082053, filed on Mar. 30, 2020.

(30) Foreign Application Priority Data
Apr. 30, 2019 (CN) 201910363207.8

(51) Int. Cl. H04N 19/103; H04N 19/142; H04N 19/179; H04N 19/172; H04N 21/234

(52) U.S. Cl. CPC H04N 19/103; H04N 19/142; H04N 21/23424; H04N 19/172; H04N 19/179

(57) ABSTRACT

A method for transmitting a video stream is provided. In the method, video data of a video to be transmitted in the video stream is obtained. Target video scenes of the video are detected. Further, target transmission parameters are determined for the video data corresponding to the respective target video scenes of the video. The video data corresponding to the respective target video scenes is encoded for transmission based on the target transmission parameters.

### RELATED APPLICATIONS

This application is a continuation of International Application No. PCT/CN2020/082053, entitled “METHOD AND APPARATUS FOR DISTRIBUTING TRANSMISSION PARAMETERS OF VIDEO RESOURCES” and filed on Mar. 30, 2020, which claims priority to Chinese Patent Application No. 201910363207.8, entitled “METHOD AND APPARATUS FOR TRANSMISSION PARAMETER DISTRIBUTION OF VIDEO RESOURCE” and filed on Apr. 30, 2019. The entire disclosures of the prior applications are hereby incorporated by reference in their entirety.

### FIELD OF THE TECHNOLOGY

This application relates to the field of computers, including transmission parameter distribution of a video resource.

### BACKGROUND OF THE DISCLOSURE

In video live streaming, in current mainstream encoding method, bitstream distribution is performed according to a fixed bit rate and a fixed resolution. When a user is not satisfied with current viewing quality or playback flow, the user needs to manually select another bit rate and another resolution for playback, and needs to wait for a conversion process.

### SUMMARY

Embodiments of this disclosure include a method and apparatus for transmitting a video stream, for example to resolve at least a technical problem of relatively poor flexibility of transmission parameter distribution of a video resource in the related art.

According to an aspect of the embodiments of this disclosure, a method for transmitting a video stream is provided. In the method, video data of a video to be transmitted in the video stream is obtained. Target video scenes of the video are detected. Further, target transmission parameters are determined for the video data corresponding to the respective target video scenes of the video. The video data corresponding to the respective target video scenes is encoded for transmission based on the target transmission parameters.

According to another aspect of the embodiments of this disclosure, an apparatus including processing circuitry is provided. The processing circuitry is configured to obtain video data of a video to be transmitted in a video stream, and detect target video scenes of the video. The processing circuitry is further configured to determine target transmission parameters for the video data corresponding to the respective target video scenes of the video. The video data corresponding to the respective target video scenes is encoded for transmission based on the target transmission parameters.

According to another aspect of the embodiments of this disclosure, a storage medium is further provided, storing a computer program, the computer program being configured to perform the method according to any one of the foregoing aspects when being run.

According to another aspect of the embodiments of this disclosure, a non-transitory computer-readable storage medium storing instructions is provided. The instructions which when executed by at least one processor cause the at least one processor to perform the foregoing method.

According to another aspect of the embodiments of this disclosure, a computer program product including instructions is further provided, the computer program product, when run on a computer, causing the computer to perform the foregoing method.

In embodiments of this disclosure a video resource to be transmitted in a video stream is obtained in a video transmission process; target video scenes corresponding to the video resource are detected, the target video scenes being scenes to which content played in the video resource belongs; and target transmission parameters corresponding to the target video scenes are distributed to the video resource, the target transmission parameters being transmission parameters used when the video resource is encoded. In this way, video scenes of the video resource to be transmitted are detected, and the target transmission parameters adapted to the target video scenes are distributed to the detected target video scenes, which ensures playback quality of the video resource in the target video scenes, thereby achieving a technical effect of improving flexibility of transmission parameter distribution of a video resource, and resolving the technical problem of relatively poor flexibility of transmission parameter distribution of a video resource in the related art.

### BRIEF DESCRIPTION OF THE DRAWINGS

The accompanying drawings described herein are used to provide a further understanding of this disclosure, and form part of this disclosure. Exemplary embodiments of this disclosure and descriptions thereof are used to explain this disclosure, and do not constitute any limitation on the scope of this disclosure. In the accompanying drawings:

FIG. 1 is a schematic diagram of an exemplary method for transmission parameter distribution of a video resource according to an embodiment of this disclosure.

FIG. 2 is a schematic diagram of an application environment of an exemplary method for transmission parameter distribution of a video resource according to an embodiment of this disclosure.

FIG. 3 is a schematic diagram of an exemplary method for transmission parameter distribution of a video resource according to an implementation of this disclosure.

FIG. 4 is a schematic diagram of an exemplary method for transmission parameter distribution of a video resource according to an implementation of this disclosure.

FIG. 5 is a schematic diagram of an exemplary apparatus for transmission parameter distribution of a video resource according to an embodiment of this disclosure.

FIG. 6 is a schematic diagram of an application scenario of an exemplary method for transmission parameter distribution of a video resource according to an embodiment of this disclosure.

FIG. 7 is a schematic diagram of an exemplary electronic device according to an embodiment of this disclosure.

### DESCRIPTION OF EMBODIMENTS

In order to help a person skilled in the art to better understand the solutions of this disclosure, the following describes technical solutions in embodiments of this disclosure with reference to the accompanying drawings. The described embodiments are only some of the embodiments of this disclosure rather than all of the embodiments. All other embodiments obtained by a person of ordinary skill in the art based on the embodiments of this disclosure shall fall within the protection scope of this disclosure.

In this specification, claims, and the accompanying drawings of this disclosure, the terms “first”, “second”, and so on are intended to distinguish similar objects but do not necessarily indicate a specific order or sequence. It is to be understood that the data used in this way may be interchanged in an appropriate case, so that the embodiments of this disclosure described herein can be implemented in a sequence other than the sequence illustrated or described herein. Moreover, the terms “include”, “contain” and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, product, or device.

According to an aspect of the embodiments of this disclosure, a method for transmission parameter distribution of a video resource is provided. The solution for transmission parameter distribution of a video resource provided in the embodiments of this disclosure is applicable to different video transmission scenarios, such as a video live streaming scenario and a video on-demand scenario. In a video live streaming scenario, a video stream may be a video live stream, and in a video on-demand scenario, a video stream may be a video on-demand stream.

The solutions provided in the embodiments of this disclosure may be executed by an electronic device, and the electronic device may be a terminal device or a server. The embodiments of this disclosure may be independently executed by a terminal device or a server, or may be applied to a network scenario in which a terminal device communicates with a server, and executed by the terminal device and the server in cooperation. The terminal device may be a smart phone (e.g., an Android mobile phone, or an iOS mobile phone), a computer, a tablet computer, a palmtop computer, a mobile Internet device (MID), a personal digital assistant (PAD), a smart television, or the like.

The server may be understood as an application server, or a Web server. During actual deployment, the server may be an independent server, or may be a cluster server or a cloud server.

For ease of description, in the following embodiments, description is made by mainly using a server as an execution body and based on an example of a video live streaming scenario.

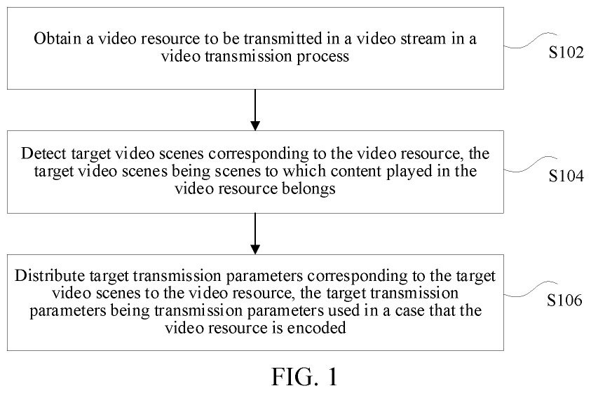

As shown in FIG. 1, the method may be performed by a server and can include the following steps.

In step S102, a video resource to be transmitted in a video stream in a video transmission process is obtained. For example, video data of a video to be transmitted in the video stream is obtained.

In step S104, target video scenes corresponding to the video resource are detected. The target video scenes are scenes to which content played in the video resource belongs. For example, target video scenes of the video are detected.

In step S106, target transmission parameters corresponding to the target video scenes are distributed to the video resource. The target transmission parameters are transmission parameters used when the video resource is encoded. For example, target transmission parameters are determined for the video data corresponding to the respective target video scenes of the video. The video data corresponding to the respective target video scenes are encoded for transmission based on the target transmission parameters.

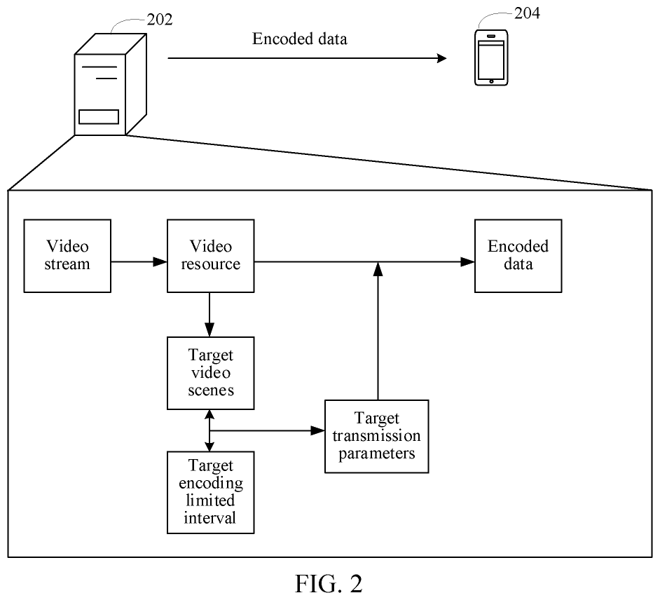

In an embodiment, the foregoing method for transmission parameter distribution of a video resource is also applicable to a hardware environment formed by a server 202 and a terminal device 204 (e.g., a smart phone) shown in FIG. 2. A client corresponding to a video live streaming service is deployed in the terminal device 204, and the client may play a video resource transmitted by the server 202 to the terminal device 204.

As shown in FIG. 2, the server 202 obtains a video resource to be transmitted in a video stream in a video transmission process; detects target video scenes corresponding to the video resource, the target video scenes being scenes to which content played in the video resource belongs; and distributes target transmission parameters corresponding to the target video scenes to the video resource.

In the video live streaming scenario, the target transmission parameters may further meet a target encoding limited interval, the target encoding limited interval being a limited range of transmission parameters of a video live stream by a live streaming channel, the live streaming channel being used for transmitting the video live stream, and the target transmission parameters being transmission parameters used when that the video resource is encoded.

The server 202 encodes the video resource by using the target transmission parameters, to obtain encoded data; and transmits the encoded data to the terminal device 204. For example, in the video live streaming scenario, the server 202 may transmit the encoded data to the terminal device 204 by using the foregoing live streaming channel.

In an embodiment, the foregoing method for transmission parameter distribution of a video resource may be, but is not limited to, applied to a scenario of distributing transmission parameters for a live stream during video live streaming, and may be, for example, alternatively applied to a scenario of distributing transmission parameters for a video stream for video on demand. The foregoing client may be, but is not limited to, various applications, such as an on-line education application, an instant messaging application, a community space application, a game application, a shopping application, a browser application, a financial application, a multimedia application, and a live streaming application. The foregoing server 202 may be, but is not limited to, a server, a server cluster, or a cloud server configured to provide live streaming services for the client in the terminal device 204. For example, the server 202 may be, but is not limited to, applied to the scenario of distributing transmission parameters for a live stream in the foregoing live streaming application, or may be, but is not limited to, applied to the scenario of distributing transmission parameters for a live stream in the foregoing browser application, to improve the flexibility of transmission parameter distribution of a video resource. This is merely an example, and this embodiment is not limited thereto.

In an embodiment, the video live stream may include, but is not limited to, live sports events, live TV programs, live streaming in a live streaming room of an anchor in a live streaming application, and the like. The video on-demand stream may include video on-demand in a video application.

In an embodiment, the target video scenes are scenes to which content played in the video resource belongs. For example, for live sports events, video scenes may include, but are not limited to: a game scene, a cheerleading performance scene, an advertising scene, a live streaming room scene, and the like. For live streaming of a variety show in TV programs, video scenes may include, but are not limited to: a performance scene, an advertising scene, a hosting scene, and the like.

In an embodiment, the target encoding limited interval may include, but is not limited to: a limited bandwidth of the live streaming channel and the like.

In an embodiment, for different video scenes, a user has different viewing expectations. For example, for a game scene, the user expects a more continuous and clearer image. In this case, target transmission parameters of a relatively high bandwidth and relatively high definition may be distributed to the game scene.

In an embodiment, video scenes may alternatively include dynamic scenes and static scenes. Transmission parameters suitable for the dynamic scenes are distributed for the dynamic scenes, and transmission parameters suitable for the static scenes are distributed for the static scenes.

As can be seen from the foregoing steps, video scenes of the video resource to be transmitted are detected, and the target transmission parameters adapted to the target video scenes are distributed to the detected target video scenes, which ensures playback quality of the video resource in the target video scenes. Further, the target transmission parameters further meet rules of the target encoding limited interval, so that the transmission of the video resource can meet transmission requirements of the transmission channel, and the transmission process is more fluid. Therefore, a technical effect of improving flexibility of transmission parameter distribution of a video resource can be achieved, and a technical problem of relatively poor flexibility of transmission parameter distribution of a video resource in the related art can be resolved.

In an exemplary solution, after the distributing target transmission parameters corresponding to the target video scenes to the video resource, the method further includes the following steps.

In a first step, the video resource is encoded by using the target transmission parameters, to obtain encoded data. The target transmission parameters include a target encoding parameter and a target resolution.

In a second step, the encoded data is transmitted.

The encoded data may be transmitted by using the live streaming channel in the video live streaming scenario.

In an embodiment, the target transmission parameters include the target encoding parameter and the target resolution, and the target encoding parameter may include, but is not limited to, an encoding rate. The encoding rates are used for ensuring the flow of video resource transmission, and the resolutions are used for ensuring the resolution of video resource playback.

In an embodiment, the target transmission parameters meet the target encoding limited interval, which ensures that the video resource can be fluidly transmitted in the live streaming channel, and avoids a freezing phenomenon in the playback process. Distributing the target resolution for the video resource can ensure that the video playback meets requirements of the user for definition.

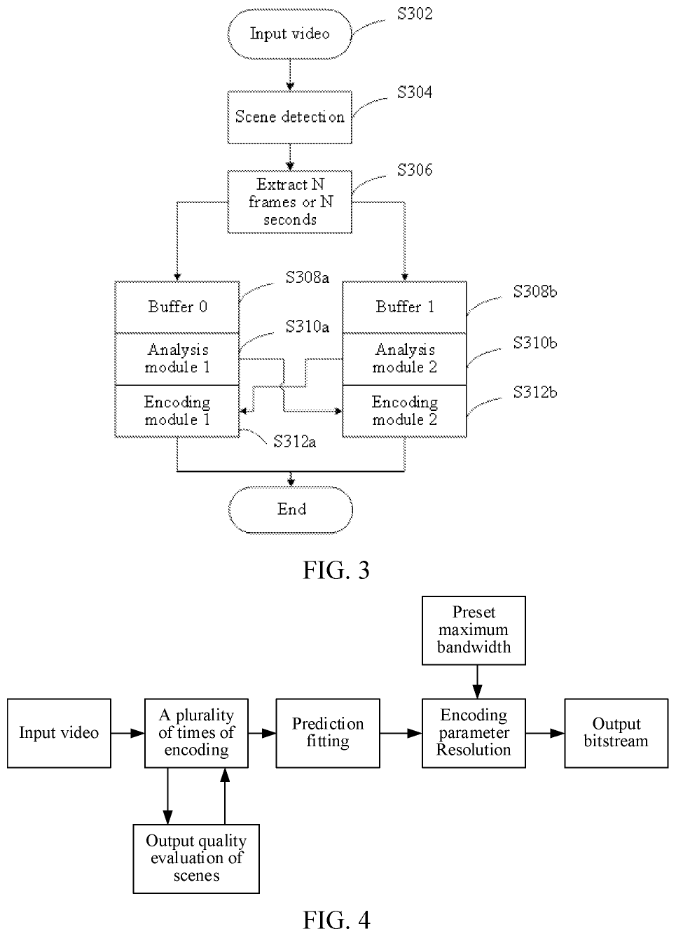

In an embodiment, there are requirements for the time for link processing in a live streaming scenario, and the time needs to meet a specific delay. Since video encoding and video analysis are relatively time-consuming, to make the processing more efficient, as shown in FIG. 3, a video can be processed through the following process.

In step S302, an input video is obtained.

In step S304, scene detection is performed on the input video.

In step S306, a video 1 of N frames or N seconds in a scene from the video is extracted, and the video 1 of N frames or N seconds is input into a Buffer 0 in step S308a. In this case, an analysis module 1 may still be processing a previous video.

In step S306, a video 2 of N frames or N seconds in a next scene is extracted from the video, and the video 2 of N frames or N seconds is input into a Buffer 1 in step S308b.

In step S310a, the analysis module 1 retrieves the video 1 of N frames or N seconds stored in the Buffer 0 from the Buffer 0, and analyzes the video according to a target encoding limited interval and transmission parameters corresponding to the scene, to obtain target transmission parameters 1. In step S310b, an analysis module 2 retrieves the video 2 of N frames or N seconds stored in the Buffer 1 from the Buffer 1, and analyzes the video according to the target encoding limited interval and transmission parameters corresponding to the scene, to obtain target transmission parameters 2.

In step S312b, an encoding module 2 encodes the video 1 according to the target transmission parameters 1. In step S312a, an encoding module 1 encodes the video 2 according to the target transmission parameters 2.

The scenes are used as a basis for segmentation, to perform ping-pong buffering with two buffers, so that encoding and analysis can be parallelized. In this way, provided that server resources are sufficient (e.g., a multi-core processor), there is only one time link of encoding and analysis, and even if an analysis link is added, the time for end-to-end output is not increased.

In an exemplary solution, the distributing target transmission parameters corresponding to the target video scenes and meeting the target encoding limited interval to the video resource can include the following steps.

In a first step, pending transmission parameters corresponding to the target video scenes are obtained from video scenes and transmission parameters that have a correspondence are obtained. The pending transmission parameters are used for ensuring that playback quality of the video resource in the target video scenes is higher than target quality.

In a second step, when a target parameter included in the pending transmission parameters exceeds a first interval corresponding to the target parameter in the target encoding limited interval, the target parameter is replaced with a maximum value of the first interval, and the pending transmission parameters obtained after the replacement are determined as the target transmission parameters.

In a third step, the pending transmission parameters are determined as the target transmission parameters when the pending transmission parameters all fall within the target encoding limited interval.

In an embodiment, the playback quality of the video resource may be measured by using, but is not limited to, parameters such as a playback delay time, an occurrence frequency of block artifacts during the playback, and a quantity of freezing during the playback.

In an embodiment, the transmission parameters having a correspondence with the video scenes may be, but are not limited to, transmission parameters that are pre-configured according to the video scenes and capable of ensuring that the playback quality of the video resource is higher than the target quality.

In an embodiment, the transmission parameters having a correspondence with the video scenes may alternatively be, but are not limited to, transmission parameters obtained by training a convolutional neural network model by using historical data such as transmission parameters and user feedback information to obtain a trained model, and automatically analyzing the video resource by using the trained model.

In an embodiment, as shown in FIG. 4, the input video is encoded for a plurality of times with reference to output quality evaluation of scenes (e.g., the foregoing target quality), and prediction fitting is performed on the plurality of times of encoding, to obtain a function relationship between a resolution, a bit rate, an encoding parameter (e.g., a constant rate factor (CRF)), and a display scene through fitting, to obtain the video scenes and the transmission parameters that have a correspondence. According to a given maximum bit rate (e.g., a preset maximum bandwidth), optimal encoding parameters and encoding resolutions are found, and the video is encoded by using the optimal encoding parameters and encoding resolutions to obtain an output bitstream, so that the quality between different scenes is continuous, and the encoding parameters meet a given target condition.

In an embodiment, the target parameters may include, but are not limited to, a transmission bit rate. When a transmission bit rate in transmission parameters corresponding to the target video scenes obtained from the video scenes and the transmission parameters that have a correspondence is higher than a limited bandwidth, to ensure the flow of transmission, the transmission bit rate may be set to the limited bandwidth, thereby ensuring the flow and resolution of video playback to the greatest extent.

In an exemplary solution, the detecting target video scenes corresponding to the video resource can includes the following steps.

In a first step, according to similarities between video frames in the video resource, a target frame in the video frames is determined. The target frame is a video frame when a video scene is switched in the video resource.

In a second step, a scene corresponding to a first video frame is determined as a first scene, and a scene corresponding to a second video frame is determined as a second scene. The first video frame is a video frame in the video resource before the target frame, the second video frame is a video frame in the video resource after the target frame, and the target video scenes includes the first scene and the second scene.

In an embodiment, if a video resource includes content of a plurality of scenes, switching points (e.g., represented by video frames) of the scenes in the video resource may be determined first, and different scenes are provided with transmission parameters adapted to the scenes respectively. In this way, transmission parameters can be switched in real time according to different scenes during video live streaming, and the flow and resolution of video playback can be ensured.

In some embodiments, encoding similarities of previous and subsequent frames may be analyzed, and when there is no encoding similarity of the previous and subsequent frames, it is considered that a scene switching point appears, that is, a target frame appears, which is not limited in this embodiment.

In an exemplary solution, the distributing target transmission parameters corresponding to the target video scenes and meeting the target encoding limited interval to the video resource can include the following steps.

In a first step, first transmission parameters are distributed to the first video frame. The first transmission parameters meet the target encoding limited interval.

In a second step, second transmission parameters are distributed to the second video frame. The second transmission parameters meet the target encoding limited interval.

For example, in a live game, a video is switched from a game image back to a live streaming room, then a target frame that switches from the game scene back to the live streaming room scene may be detected, first transmission parameters suitable for the game scene are distributed to a video frame before the target frame, and second transmission parameters suitable for the live streaming room scene are distributed to a video frame after the target frame.

In an exemplary solution, the distributing target transmission parameters corresponding to the target video scenes and meeting the target encoding limited interval to the video resource can include the following steps.

In a first step, playback parameters of a target device are obtained. The target device is a device configured to play the video stream, and the playback parameters are image parameters for playback the video stream on the target device.

In a second step, third transmission parameters corresponding to the target video scenes are obtained.

In a third step, the third transmission parameters are adjusted to fourth transmission parameters that meet the target encoding limited interval.

In a fourth step, the fourth transmission parameters are adjusted to the target transmission parameters that meet the playback parameters.

In an embodiment, the target transmission parameters may alternatively be determined with reference to the target device configured to play the video stream. For example, if a screen of the target device is relatively large, that is, a size of the image in the playback parameter is relatively large, a bitstream with a relatively high resolution may be configured for the target device. If a screen of the target device is relatively small, that is, a size of the image in the playback parameter is relatively small, a bitstream with a relatively lower resolution may be configured for the target device. If the processing capability of the target device is relatively poor, such as the transmission capability for played images in the playback parameters is relatively poor, a bitstream with a relatively low bit rate may be configured for the target device.

In an embodiment, the target transmission parameters are adjusted according to the target encoding limited interval of the transmission channel and the playback parameters of the target device, so that transmission parameters of a live stream can be distributed more flexibly, and requirements of the user for viewing can be better satisfied.

For ease of description, the foregoing method embodiments are stated as a combination of a series of actions. However, a person skilled in the art would understand that this disclosure is not limited by the described action sequence. For example, some steps may be performed in another sequence or simultaneously. In addition, a person skilled in the art would understand that the embodiments described in this disclosure are all exemplary embodiments, and the involved actions and modules are not necessarily required by this disclosure.

According to the descriptions in the foregoing implementations, a person skilled in the art would understand that the method according to the foregoing embodiment may be implemented by relying on software and a commodity hardware platform or by using hardware. Based on such an understanding, the technical solutions of this disclosure may be implemented in the form of a software product. The computer software product may be stored in a storage medium, such as a read-only medium (ROM)/a random access memory (RAM), a magnetic disk, or an optical disc, and includes several instructions for instructing the foregoing electronic device to perform the method described in the embodiments of this disclosure. The storage medium may be a non-transitory computer-readable storage medium for example.

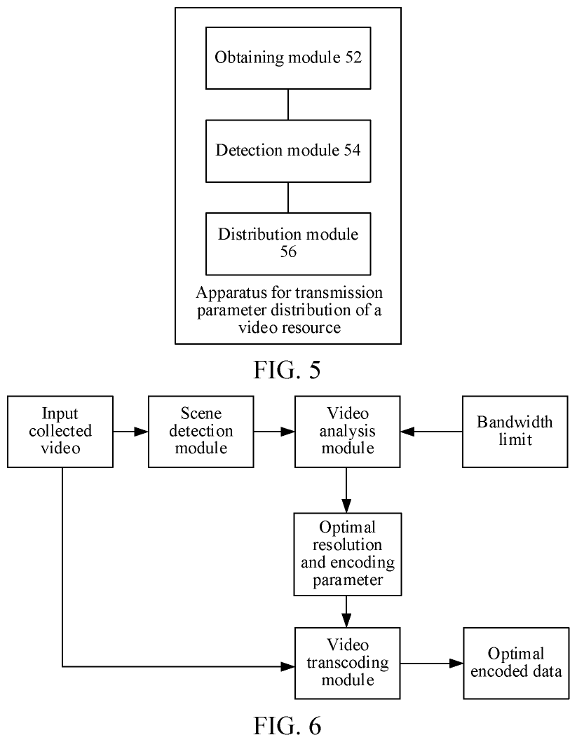

According to another aspect of the embodiments of this disclosure, an apparatus for transmission parameter distribution of a video resource configured to implement the foregoing method for transmission parameter distribution of a video resource is further provided. As shown in FIG. 5, the apparatus can include an obtaining module 52, a detection module 54, and a distribution module 56. One or more modules of the apparatus can be implemented by processing circuitry, software, or a combination thereof, for example.

The obtaining module 52 is configured to obtain a video resource to be transmitted in a video stream in a video transmission process. The detection module 54 is configured to detect target video scenes corresponding to the video resource, the target video scenes being scenes to which content played in the video resource belongs. The distribution module 56 is configured to distribute target transmission parameters corresponding to the target video scenes to the video resource, the target transmission parameters being transmission parameters used when the video resource is encoded.

The target transmission parameters meet a target encoding limited interval, the target encoding limited interval is a limited range of transmission parameters of the video stream by a transmission channel, the transmission channel being used for transmitting the video stream.

In an embodiment, the apparatus further includes an encoding module and a transmission module. The encoding module is configured to encode the video resource by using the target transmission parameters, to obtain encoded data, the target transmission parameters including a target encoding parameter and a target resolution. The transmission module is configured to transmit the encoded data.

In an embodiment, the distribution module includes a first obtaining unit, a replacement unit, and a first determining unit. The first obtaining unit is configured to obtain pending transmission parameters corresponding to the target video scenes from video scenes and transmission parameters that have a correspondence, the pending transmission parameters being used for ensuring that playback quality of the video resource in the target video scenes is higher than target quality. The replacement unit is configured to replace, when a target parameter included in the pending transmission parameters exceeds a first interval corresponding to the target parameter in the target encoding limited interval, the target parameter with a maximum value of the first interval, and determining the pending transmission parameters obtained after the replacement as the target transmission parameters. The first determining unit is configured to determine the pending transmission parameters as the target transmission parameters when the pending transmission parameters all fall within the target encoding limited interval.

In an embodiment, the foregoing detection module includes a second determining unit and a third determining unit. The second determining unit is configured to determine, according to similarities between video frames in the video resource, a target frame in the video frames, the target frame being a video frame when a video scene is switched in the video resource. The third determining unit is configured to determine a scene corresponding to a first video frame as a first scene, and determine a scene corresponding to a second video frame as a second scene, the first video frame being a video frame in the video resource before the target frame, the second video frame being a video frame in the video resource after the target frame, and the target video scenes including the first scene and the second scene.

In an embodiment, the distribution module includes a first distribution unit and a second distribution unit. The first distribution unit is configured to distribute first transmission parameters to the first video frame, the first transmission parameters meeting the target encoding limited interval. The second distribution unit is configured to distribute second transmission parameters to the second video frame, the second transmission parameters meeting the target encoding limited interval.

In an embodiment, the distribution module includes a second obtaining unit, a third obtaining unit, a first adjustment unit, and a second adjustment unit. The second obtaining unit is configured to obtain playback parameters of a target device, the target device being a device configured to play the video stream, and the playback parameters being image parameters for playback of the video stream on the target device. The third obtaining unit is configured to obtain third transmission parameters corresponding to the target video scenes. The first adjustment unit is configured to adjust the third transmission parameters to fourth transmission parameters that meet the target encoding limited interval. The second adjustment unit is configured to adjust the fourth transmission parameters to the target transmission parameters that meet the playback parameters.

For an application environment of this embodiment of this disclosure, reference may be made to, but is not limited to, the application environment of the foregoing embodiment. This is not described in detail in this embodiment. This embodiment of this disclosure provides an exemplary application for implementing the foregoing method for transmission parameter distribution of a video resource.

In an exemplary embodiment, the foregoing method for transmission parameter distribution of a video resource may be, but is not limited to, applied to a scenario of distributing transmission parameters to a video live stream shown in FIG. 6. In this scenario, a system for transmission parameter distribution is provided. The system includes the following modules: a scene detection module, a video analysis module, and a video transcoding module. The input of the scene detection module is a collected original video; target video scenes corresponding to the current video are obtained; the target video scenes and a currently detected network bandwidth limit are inputted to the video analysis module; an optimal bitstream that meets the limit is outputted; and for the bitstream, a bit rate and a resolution of the bitstream outputted are dynamically changed according to scene switching, so that the video transcoding module, after transcoding the original video resource according to the optimal bitstream, outputs a bitstream in which encoding block artifacts of the current scene is eliminated under specific bandwidth requirements, and the resolution is maximized while there is no block artifact, thereby achieving clear large-screen playback experience. Since when the foregoing system changes the encoding parameters, the encoding scenes are changed, for human eyes, a moderate quality change cannot be noticed when the encoding scenes are changed, which ensures the quality of the entire video is consistent.

Through the foregoing system, a live video is encoded based on a real-time bandwidth, an adaptive resolution of a video scene, and bit rate encoding, which alleviates the problem of bit rate fluctuations in the related live streaming scheme, and can ensure the accuracy of video analysis and moderate adaptability of human eyes for quality changes when scenes are switched.

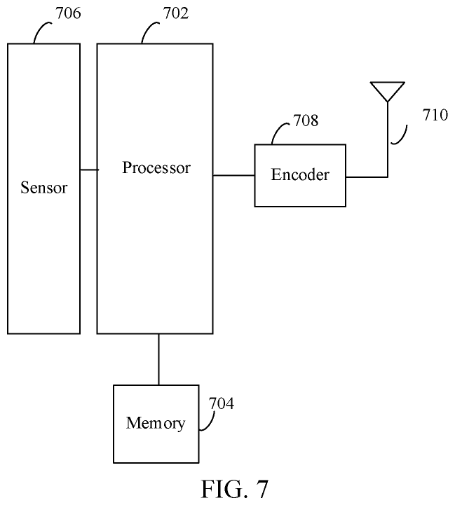

According to still another aspect of the embodiments of this disclosure, an electronic device for implementing the foregoing transmission parameter distribution of a video resource is further provided. The electronic device may be, for example, the server 202 shown in FIG. 2. As shown in FIG. 7, the electronic device includes: one or more (only one is shown in the figure) processors 702, a memory 704, a sensor 706, an encoder 708, a transmission apparatus 710, a communication interface (not shown), and a communication bus (not shown). The memory stores a computer program, and processing circuitry such as the processor is configured to perform the steps in any one of the foregoing method embodiments by using the computer program.

In an embodiment, the electronic device may be located in at least one of a plurality of network devices in a computer network.

In an embodiment, the processor may be configured to perform the following steps by using the computer program.

In a first step, a video resource to be transmitted in a video stream is obtained in a video transmission process.

In a second step, target video scenes corresponding to the video resource are detected. The target video scenes are scenes to which content played in the video resource belongs.

In a third step, target transmission parameters corresponding to the target video scenes are distributed to the video resource. The target transmission parameters are transmission parameters used when the video resource is encoded.

A person of ordinary skill in the art would understand that the structure shown in FIG. 7 is only for the purpose of illustration, and is not a limitation on the structure of the foregoing electronic device. For example, the electronic device may further include more or fewer components (e.g., a network interface and a display apparatus) than those shown in FIG. 7, or has a distribution different from that shown in FIG. 7.

The memory 704 may be configured to store a software program and module, for example, a program instruction/module corresponding to the method and apparatus for transmission parameter distribution of a video resource in the embodiments of this disclosure. The processor 704 runs the software program and module stored in the memory 704, to perform various functional applications and data processing, that is, implement the foregoing method for transmission parameter distribution of a video resource. The memory 704 may include a high-speed random access memory, and may also include a non-volatile memory, for example, one or more magnetic storage apparatuses, a flash memory, or another non-volatile solid-state memory. In some instances, the memory 704 may further include memories remotely disposed relative to the processor 702, and these remote memories may be connected to the electronic device by using a network. Examples of the network include, but are not limited to, the Internet, an intranet, a local area network, a mobile communication network, and a combination thereof.

The transmission apparatus 710 is configured to receive or send data by using a network, and is a communication interface for example. Specific examples of the network may include a wired network and a wireless network. In an example, the transmission apparatus 710 includes a network interface controller (NIC). The NIC may be connected to another network device and a router by using a network cable, so as to communicate with the Internet or a local area network. In an example, the transmission apparatus 710 is a radio frequency (RF) module, which communicates with the Internet in a wireless manner.

In an embodiment, the memory 704 is configured to store an application.

An embodiment of this disclosure further provides a storage medium, storing a computer program, the computer program being used for performing steps in any one of the foregoing method embodiments when being run. The storage medium may be a non-transitory computer-readable storage medium for example.

In an embodiment, the storage medium may be set to store a computer program for performing the following steps.

In a first step, a video resource to be transmitted in a video stream is obtained in a video transmission process.

In a second step, target video scenes corresponding to the video resource are detected. The target video scenes are scenes to which content played in the video resource belongs.

In a third step, target transmission parameters corresponding to the target video scenes are distributed to the video resource. The target transmission parameters are transmission parameters used when the video resource is encoded.

In an embodiment, the storage medium is further configured to store a computer program used for performing the steps included in the methods according to the foregoing embodiments, and details are not described again in this embodiment.

In an embodiment, a person of ordinary skill in the art would understand that all or some of the steps of the methods in the foregoing embodiments may be implemented by a program instructing relevant hardware of the terminal device. The program may be stored in a computer-readable storage medium, and the storage medium may include a flash disk, a read-only memory (ROM), a random access memory (RAM), a magnetic disk, an optical disc, or the like.

An embodiment of this disclosure further provides a computer program product including instructions, the computer program product, when run on an electronic device, causing the electronic device to perform the methods according to the foregoing embodiments.

The sequence numbers of the foregoing embodiments of this disclosure are merely for description purposes and do not imply the preference among the embodiments.

When the integrated unit in the foregoing embodiments is implemented in a form of a software functional unit and sold or used as an independent product, the integrated unit may be stored in the foregoing computer-readable storage medium. Based on such an understanding, the technical solutions of this disclosure may be implemented, at least in part, in a form of a software product. The computer software product is stored in a storage medium and includes several instructions for instructing one or more computer devices (which may be a personal computer, a server, a network device, and the like) to perform all or some of the steps of the methods described in the embodiments of this disclosure.

In the foregoing embodiments of this disclosure, descriptions of the embodiments have respective focuses. As for parts that are not described in detail in one embodiment, reference may be made to the relevant descriptions of the other embodiments.

In the several embodiments provided in this disclosure, it is to be understood that, the disclosed client may be implemented in another manner. The apparatus embodiments described above are merely exemplary. For example, the division of the units is merely the division of logic functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, functional units in the embodiments of this disclosure may be integrated into one processing unit, or each of the units may be physically separated, or two or more units may be integrated into one unit. The integrated unit may be implemented in the form of hardware, or may be implemented in a form of a software functional unit.

The foregoing descriptions are merely exemplary implementations of this disclosure. A person of ordinary skill in the art may further make several improvements and modifications without departing from the principle of this disclosure, and the improvements and modifications are also considered as falling within the protection scope of this disclosure.

What is claimed is:

1. A method for transmitting a video stream the method comprising:
obtaining video data of a video to be transmitted in the video stream;
detecting target video scenes of the video; and
determining, by processing circuitry, target transmission parameters for the video data corresponding to the respective target video scenes of the video, the video data corresponding to the respective target video scenes being encoded for transmission based on the target transmission parameters.

2. The method according to claim 1, wherein the determining comprises:
determining the target transmission parameters for the video data corresponding to each of the target video scenes based on which of a plurality of scene types is determined to correspond to the respective target video scene.

3. The method according to claim 1, wherein the determining comprises:
determining whether the target transmission parameters are within a target encoding limited interval, the target encoding limited interval being based on a limitation of a transmission channel in which the video stream is to be transmitted.

4. The method according to claim 1, further comprising:
encoding the video data according to the target transmission parameters, to obtain encoded data, the target transmission parameters including a target encoding parameter and a target resolution; and
transmitting the encoded data.

5. The method according to claim 3, wherein the determining comprises:
obtaining initial transmission parameters for the video data corresponding to the target video scenes, the initial transmission parameters including a target parameter;
replacing, when the target parameter exceeds an interval corresponding to the target parameter in the target encoding limited interval, the target parameter with a maximum value of the interval, and determining the initial transmission parameters obtained after the replacement as the target transmission parameters; and
determining the initial transmission parameters as the target transmission parameters when the initial transmission parameters all fall within the target encoding limited interval.

6. The method according to claim 3, wherein the detecting comprises:
determining, according to similarities between video frames in the video, a target frame in the video frames, the target frame corresponding to a video scene switch in the video;
determining a first scene corresponding to a first video frame; and
determining a second scene corresponding to a second video frame, the first video frame being before the target frame, the second video frame being after the target frame, and the target video scenes including the first scene and the second scene.

7. The method according to claim 6, wherein when the target transmission parameters are within the target encoding limited interval, the determining comprises:
determining first transmission parameters for the first video frame, the first transmission parameters being within the target encoding limited interval; and
determining second transmission parameters for the second video frame, the second transmission parameters being within the target encoding limited interval.

8. The method according to claim 3, wherein the determining comprises:
obtaining playback parameters of a target device configured to play back the video stream, the playback parameters including image parameters for playing back the video stream on the target device;
obtaining third transmission parameters corresponding to the target video scenes;
adjusting the third transmission parameters to fourth transmission parameters that are within the target encoding limited interval; and
adjusting the fourth transmission parameters to the target transmission parameters based on the playback parameters.

9. The method according to claim 2, wherein
the target video scenes include a first video scene of a first scene type and a second video scene of a second scene type that is different from the first scene type, and
the target transmission parameters for the video data corresponding to the first video scene are different from the target transmission parameters for the video data corresponding to the second video scene.

10. The method according to claim 2, wherein the plurality of scene types includes a primary content scene and an advertisement scene.

11. An apparatus, comprising:
processing circuitry configured to:
obtain video data of a video to be transmitted in a video stream;
detect target video scenes of the video; and
determine target transmission parameters for the video data corresponding to the respective target video scenes of the video, the video data corresponding to the respective target video scenes being encoded for transmission based on the target transmission parameters.

12. The apparatus according to claim 11, wherein the processing circuitry configured to:
determine the target transmission parameters for the video data corresponding to each of the target video scenes based on which of a plurality of scene types is determined to correspond to the respective target video scene.

13. The apparatus according to claim 11, wherein the processing circuitry configured to:
determine whether the target transmission parameters are within a target encoding limited interval, the target encoding limited interval being based on a limitation of a transmission channel in which the video stream is to be transmitted.

14. The apparatus according to claim 11, wherein the processing circuitry configured to:
encode the video data according to the target transmission parameters, to obtain encoded data, the target transmission parameters including a target encoding parameter and a target resolution; and
transmit the encoded data.

15. The apparatus according to claim 13, wherein the processing circuitry configured to:
obtain initial transmission parameters for the video data corresponding to the target video scenes, the initial transmission parameters including a target parameter;
replace, when the target parameter exceeds an interval corresponding to the target parameter in the target encoding limited interval, the target parameter with a maximum value of the interval, and determining the initial transmission parameters obtained after the replacement as the target transmission parameters; and
determine the initial transmission parameters as the target transmission parameters when the initial transmission parameters all fall within the target encoding limited interval.

16. The apparatus according to claim 13, wherein the processing circuitry configured to:
determine, according to similarities between video frames in the video, a target frame in the video frames, the target frame corresponding to a video scene switch in the video;
determine a first scene corresponding to a first video frame; and
determine a second scene corresponding to a second video frame, the first video frame being before the target frame, the second video frame being after the target frame, and the target video scenes including the first scene and the second scene.

17. The apparatus according to claim 16, wherein when the target transmission parameters are within the target encoding limited interval, the processing circuitry is configured to:
determine first transmission parameters for the first video frame, the first transmission parameters being within the target encoding limited interval; and
determine second transmission parameters for the second video frame, the second transmission parameters being within the target encoding limited interval.

18. The apparatus according to claim 13, wherein the processing circuitry is configured to:
obtain playback parameters of a target device configured to play back the video stream, the playback parameters including image parameters for playing back the video stream on the target device;
obtain third transmission parameters corresponding to the target video scenes;
adjust the third transmission parameters to fourth transmission parameters that are within the target encoding limited interval; and
adjust the fourth transmission parameters to the target transmission parameters based on the playback parameters.

19. The apparatus according to claim 12, wherein
the target video scenes include a first video scene of a first scene type and a second video scene of a second scene type that is different from the first scene type, and
the target transmission parameters for the video data corresponding to the first video scene are different from the target transmission parameters for the video data corresponding to the second video scene.

20. A non-transitory computer-readable storage medium storing instructions which when executed by at least one processor cause the at least one processor to perform:
obtaining video data of a video to be transmitted in a video stream;
detecting target video scenes of the video; and
determining target transmission parameters for the video data corresponding to the respective target video scenes of the video, the video data corresponding to the respective target video scenes being encoded for transmission based on the target transmission parameters.
